(19) United States
(12) Patent Application Publication
(10) Pub. No.: US 2019/0331223 A1
(43) Pub. Date: Oct. 31, 2019

(54) Axial Face Seal Assembly with Improved Abrasion Resistance

(71) Applicant: Aktiebolaget SKF, Goteborg (SE)

(72) Inventors: Tyler James Ryther, West Valley, UT (US); Anthony Todd Hagen, Sandy, UT (US); Daniel Paul Hurst, West Jordan, UT (US)

(21) Appl. No.: 15/962,401

(22) Filed: Apr. 25, 2018

(51) Int. Cl. F16J 15/00

(52) U.S. Cl. CPC F16J 15/002

(57) ABSTRACT

A seal assembly includes a generally annular primary seal member formed of a first, generally compressible polymeric material. The primary seal member has inner and outer radial ends, a first axial end disposeable against a first tubular member end surface and a second axial end disposeable against the second tubular member end surface. The first axial end has a radially-extending, generally annular primary sealing surface sealingly engageable with the first tubular member end surface. A generally annular secondary seal member is formed of a second, generally rigid polymeric material. The secondary seal member has two opposing axial ends and a radially-extending, generally annular secondary sealing surface on a first axial end. The secondary seal member is coupled with the first seal member such that the secondary sealing surface extends generally coaxially about the primary sealing surface, the secondary sealing surface being sealingly engageable with the first tubular member end surface.

### BACKGROUND OF THE INVENTION

The present invention relates to seal assemblies, and more particularly to axial face seals used in abrasive environments.

Axial face seals are known and typically include an annular seal body formed of an elastomeric material. The seal body has at least one radial-extending surface on an axial end which sealingly engages an annular surface or “face” of a component, such as a drill pipe. Particularly when used in a highly abrasive environment, such in as a fracking pipe-line swivel joint, the combination of relative rotation of one pipe and the abrasive materials in the fracking fluid often cause degradation of the seal body material and possible failure of the seal.

### SUMMARY OF THE INVENTION

In one aspect, the present invention is a seal assembly for sealing between first and second tubular members, each tubular member having a central passage and a generally annular end surface surrounding the passage. The first member passage is fluidly coupled with the second member passage and the first member end surface faces and is spaced apart from the second member end surface along a central axis. Also, the first member is angularly displaceable about the axis with respect to the second member. The seal assembly comprises a generally annular primary seal member formed of a first, generally compressible polymeric material. The primary seal member has inner and outer radial ends, a first axial end disposeable against the first tubular member end surface and a second axial end disposeable against the second tubular member end surface. The first axial end has a radially-extending, generally annular primary sealing surface sealingly engageable with the first tubular member end surface. A generally annular secondary seal member is formed of a second, generally rigid polymeric material. The secondary seal member has opposing first and second axial ends and a radially-extending, generally annular secondary sealing surface on the first axial end. The secondary seal member is coupled with the first seal member such that the secondary sealing surface extends generally coaxially about the primary sealing surface, the secondary sealing surface being sealingly engageable with the first tubular member end surface.

In another aspect, the present invention is a mechanical assembly comprising a first tubular member having a central passage and a generally annular end surface surrounding the passage and a second tubular member having a central passage and a generally annular end surface surrounding the passage. The first member end surface faces and is spaced apart along a central axis from the second member end surface and the first member is angularly displaceable about the axis with respect to the second member. A seal assembly is provided for sealing between the first and second member end surfaces and includes a generally annular primary seal member formed of a first, generally compressible polymeric material. The primary seal member has inner and outer radial ends, a first axial end disposeable against the first tubular member end surface and a second axial end disposeable against the second tubular member end surface. The first axial end has a radially-extending, generally annular primary sealing surface sealingly engageable with the first tubular member end surface. A generally annular secondary seal member is formed of a second, generally rigid polymeric material. The secondary seal member has opposing first and second axial ends and a radially-extending, generally annular secondary sealing surface on the first axial end. The secondary seal member is coupled with the first seal member such that the secondary sealing surface extends generally coaxially about the primary sealing surface. The secondary sealing surface is also sealingly engageable with the first tubular member end surface.

### BRIEF DESCRIPTION OF THE SEVERAL VIEWS OF THE DRAWINGS

The foregoing summary, as well as the detailed description of the preferred embodiments of the present invention, will be better understood when read in conjunction with the appended drawings. For the purpose of illustrating the invention, there is shown in the drawings, which are diagrammatic, embodiments that are presently preferred. It should be understood, however, that the present invention is not limited to the precise arrangements and instrumentalities shown. In the drawings:

FIG. 1 is a broken-away, axial cross-sectional view of a mechanical assembly including a seal assembly in accordance with the present invention:

FIG. 2 is a greatly enlarged view of a portion of FIG. 1;

FIG. 3 is a top plan view of the seal assembly, shown in a “free” or uninstalled state;

FIG. 4 is an axial cross-sectional view of the seal assembly through line 4-4 of FIG. 3;

FIG. 5 is an enlarged, broken-away view of a portion of FIG. 4; and

FIG. 6 is a broken-away, axial cross-sectional view of a primary seal member of the seal assembly.

### DETAILED DESCRIPTION OF THE INVENTION

Certain terminology is used in the following description for convenience only and is not limiting. The words “inner”, “inwardly” and “outer”, “outwardly” refer to directions toward and away from, respectively, a designated centerline or a geometric center of an element being described, the particular meaning being readily apparent from the context of the description. Further, as used herein, the words “connected” and “coupled” are each intended to include direct connections between two members without any other members interposed therebetween and indirect connections between members in which one or more other members are interposed therebetween. The terminology includes the words specifically mentioned above, derivatives thereof, and words of similar import.

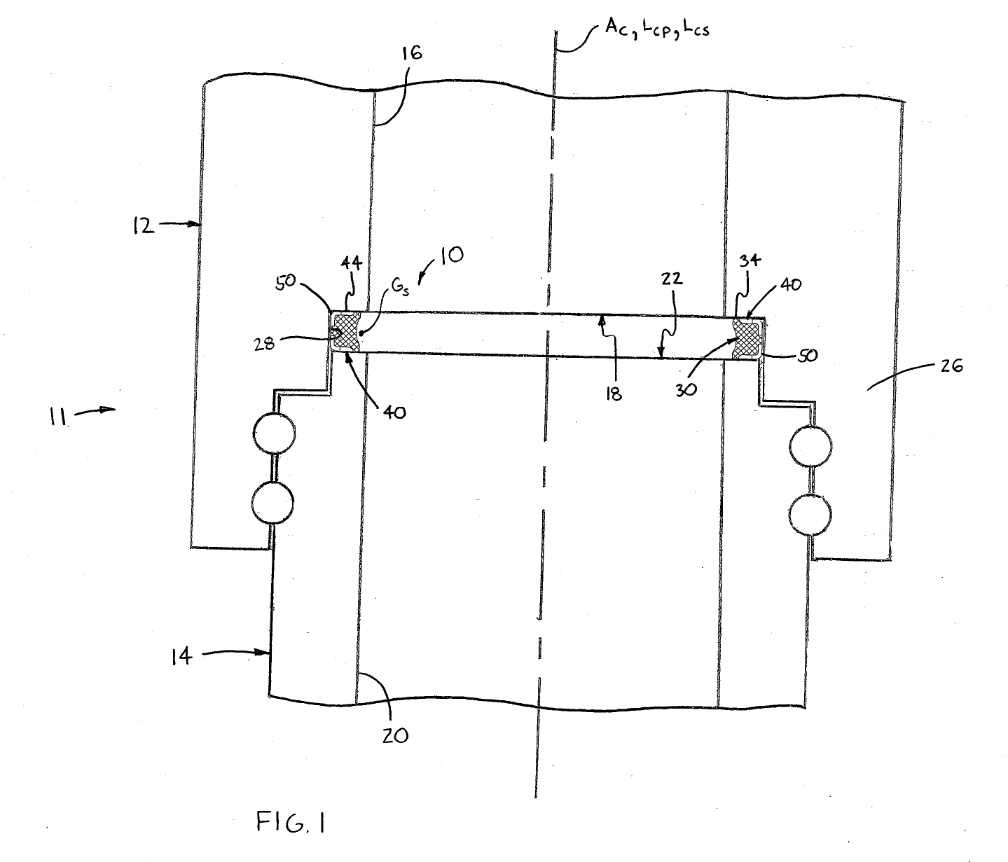

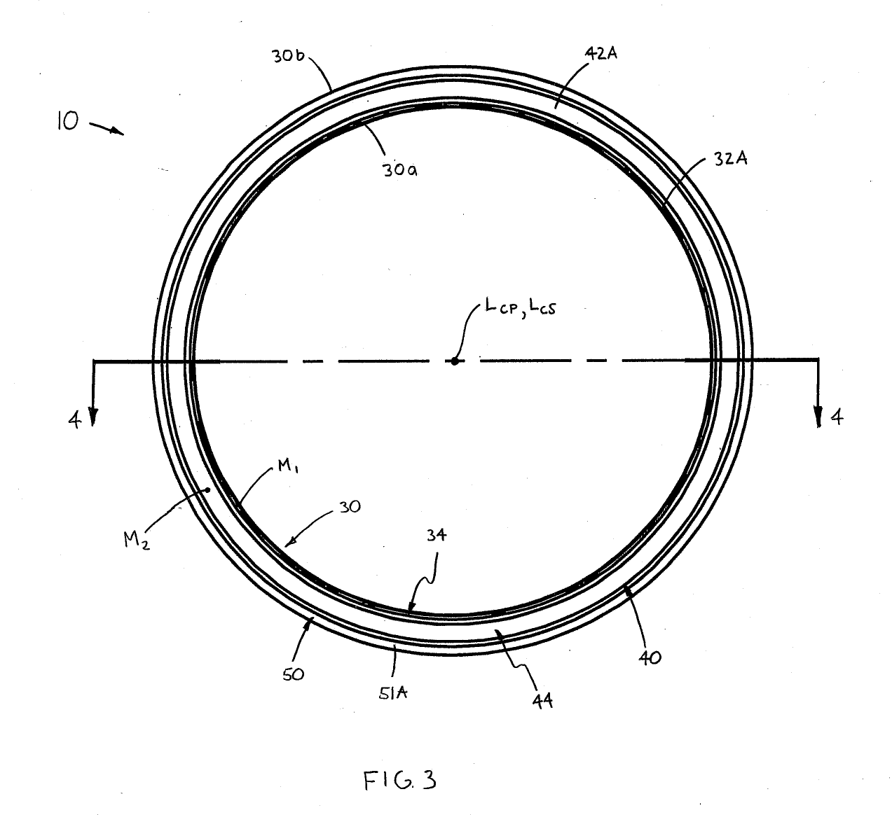

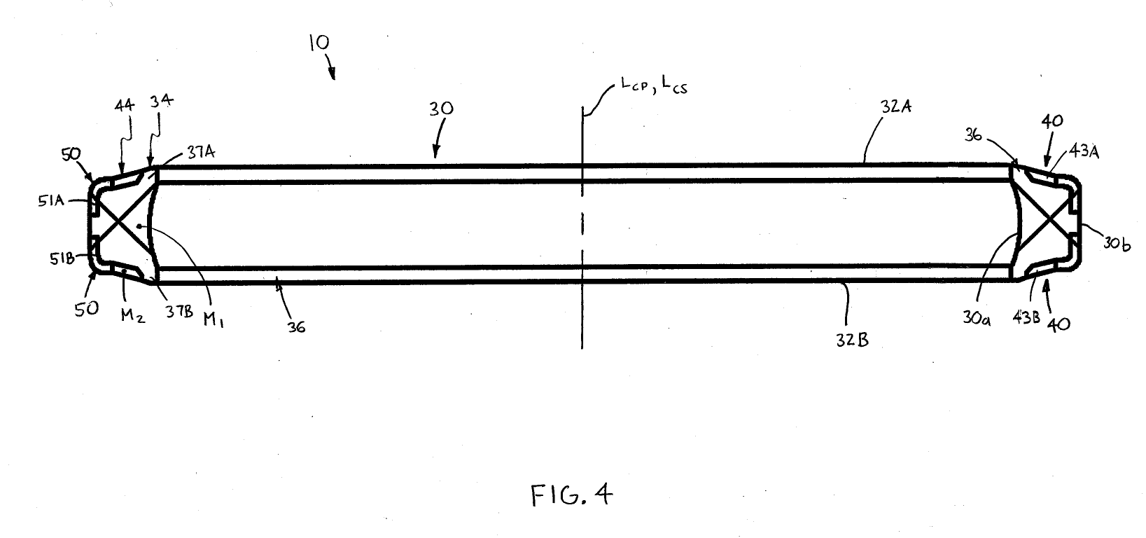

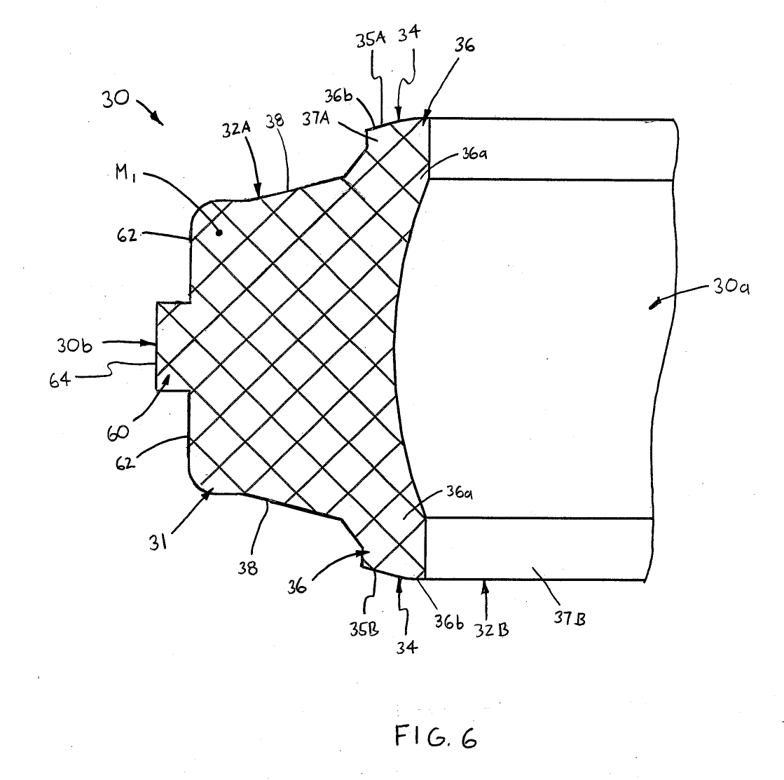

Referring now to the drawings in detail, wherein like numbers are used to indicate like elements throughout, there is shown in FIGS. 1-6 an axial face seal assembly 10 for sealing between first and second tubular members 12, 14, respectively, which collectively form a mechanical assembly 11. The mechanical assembly 11 is preferably a swivel joint of a pipe assembly for transporting fluids such as fracking fluid, but may be any other assembly of mechanical parts or components utilizing an axial face seal. The first tubular member 12 has a central passage 16 and a generally annular end surface 18 surrounding the passage 16 and the second tubular member 14 has a central passage 20 and a generally annular end surface 22 surrounding the passage 20. The first member end surface 18 faces and is spaced apart along a central axis A_{C} from the second member end surface 22, so as to define a generally annular space or seal “gland” G_{S}, and at least the first tubular member 12 is angularly displaceable about the axis A_{C} with respect to the second tubular member 14. Preferably, the first tubular member 12 further has a collar portion 26 extending axially outwardly from and surrounding the end surface 18, which provides an inner circumferential surface 28 which encloses the radially outer end of the annular gland G_{S}. The seal assembly 10 is disposeable within the gland G_{S} and basically comprises a generally annular primary seal member 30 formed of a first, generally compressible polymeric material M₁ and a generally annular secondary seal member 40 formed of a second, generally rigid polymeric material M₂ and coupled with the primary seal member 30. Each seal member 30, 40 has a radially-extending, generally annular sealing surface 34, 44, respectively, sealingly engageable with the first tubular member annular surface 18, as described in detail below.

The second polymeric material M₂ has a coefficient of friction substantially lesser than the coefficient of friction of the first material M₁. As such, the secondary seal member 40 experiences substantially less wear and generates substantially less heat during angular displacement of the first tubular member 12, during which the tubular member annular surface 18 slidably displaces against the sealing surfaces 34, 44. Preferably, the first polymeric material M₁ is an elastomer, such as natural or synthetic rubber, most preferably a highly chemical compatible elastomer such as highly saturated nitrile, e.g., hydrogenated nitrile butadiene rubber (“HNBR”), an FKM fluoroelastomer (“FKM”), or any other generally similar materials. The second polymeric material M₂ is preferably a thermoplastic polymer, most preferably polytetrafluorethylene (“PTFE”) or alternatively nylon, Delrin, or any other generally similar materials.

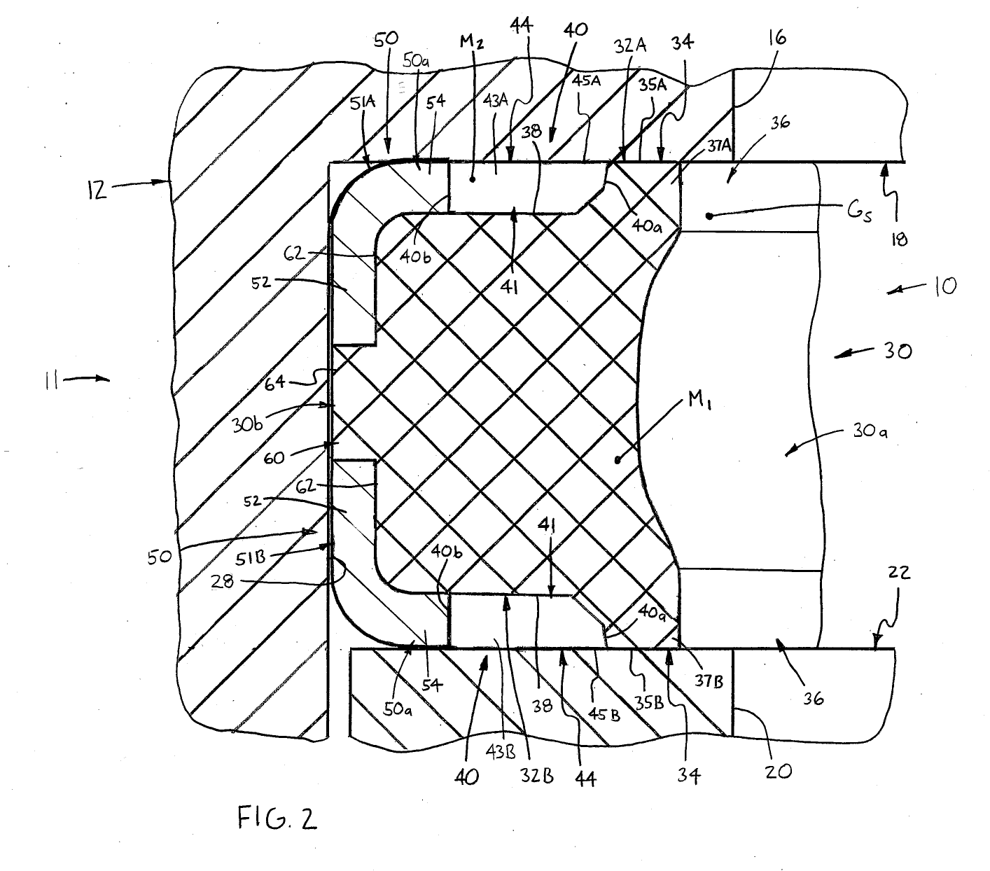

The primary seal member 30 includes a generally annular body 31 having a centerline L_{CP}, inner and outer radial ends 30a, 30b, a first axial end 32A and a second axial end 32B, as indicated in FIGS. 2, 5 and 6. The two axial ends 32A, 32B are spaced apart along the centerline L_{CP} and at least the first axial end 32A, and preferably each one of the ends 32A, 32B, has a radially-extending, generally annular primary sealing surface 34. The first axial end 32A is disposeable against the first tubular member end surface 18, such that the primary sealing surface 34 is sealingly engageable with the annular end surface 18, and the second axial end 32B is disposeable against the second tubular member end surface 22.

Thus, when the seal assembly 10 is installed within the seal gland G_{S}, axial displacement of one of the tubular members 12, 14 toward the other member 14, 12 compresses the primary seal member 30 between the two end surfaces 18, 22. Conversely, the primary seal member 30 decompresses or expands during axial displacement of one of the tubular members 12, 14 away from the other member 14, 12 to maintain contact with the end surfaces 18, 22 of the tubular members 12, 14, respectively. Thereby, sealing engagement of the primary sealing surface 34 with the first tubular member end surface 18 is maintained during angular displacement of the first tubular member 12 or/and axial displacement of either tubular member 12 or 14.

Referring to FIGS. 2, 4 and 5, the secondary seal member 40 is preferably formed as washer-like annular plate 41 and has inner and outer radial ends 40a, 40b, respectively, and opposing first and second axial ends 42A, 42B, respectively, spaced apart along a centerline L_{CS} (collinear with the primary seal member centerline L_{CP}). A radially-extending, generally annular secondary sealing surface 44 is provided on the first axial end 42A and is sealingly engageable with the first tubular member end surface 18. The secondary seal member 40 is coupled with the first seal member 30 such that the secondary sealing surface 44 extends generally coaxially about the primary sealing surface 34.

With the structure of the two seal members 30, 40, both the primary sealing surface 34 and surrounding secondary sealing surface 44 are engaged with the end surface 18 of the first tubular member 12 when the seal assembly 10 is installed within the seal gland G_{S}, with the primary seal member 30 preferably being generally in a state of compression. When one of the first and second tubular members 12, 14 displaces axially toward the other one of the first and second tubular members 14, 12, the primary seal member 30 compresses, or compresses further, between the first and second tubular members 12, 14. During such compression of the primary seal member 30, the secondary sealing surface 44 remains sealingly engaged with the first tubular member 12 as the secondary seal member 40 displaces axially with the compressed “backing” portion of the primary seal member 30. i.e., the portion of the seal member 30 between the secondary seal member 40 and the second tubular member 14. Alternatively, when one of the first and second members 12, 14 displaces axially away from the other tubular member 14, 12, the primary seal member 30 expands between the first and second tubular members 12, 14 while the secondary sealing surface 44 remains sealingly engaged with the first tubular member 12 as the secondary seal member 40 is displaced or biased by the “backing portion” of the primary seal member 30.

Thus, the structure of the rigid secondary seal member 40 being coupled with and carried by the compressible primary seal member 30 ensures that sealing engagement of both sealing surfaces 34, 44 is maintained during relative angular and/or axial displacement of the tubular members 12, 14. Further, due to the substantially lesser coefficient of friction of the secondary seal member 40, the amount of heat generated during relative angular displacement of the first and second tubular members 12, 14 is significantly reduced. Thereby, material degradation of the primary seal member 30, particularly within the region of the sealing surface 34, is also substantially reduced or even entirely eliminated in comparison with previously known axial “face” seals.

Referring now to FIGS. 1-5, the seal assembly 10 preferably further comprises a metallic backing ring 50 coupled with the primary seal member 30 such that a portion 50a of the backing ring 50 is disposeable against the first tubular member end surface 18. As such, the secondary seal member 40 is disposed radially between the backing ring 50 and the primary seal member inner radial end 30a, more specifically between the ring radial portion 50a and the primary seal member sealing surface 34. The backing ring 50 functions to reinforce the outer radial end 30b of the primary seal member 30 so as to prevent, or at least reduce, “extrusion” or radially-outward displacement of the primary seal member 30 due to pressure on the inner radial end 30a.

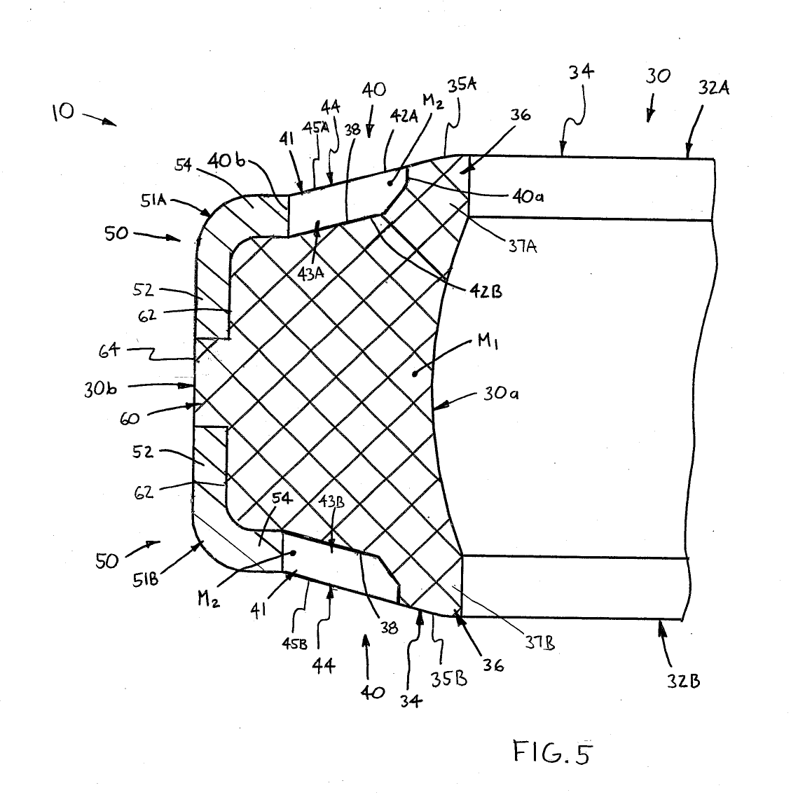

Preferably, the backing ring 50 has generally L-shaped axial cross-sections and includes an axially-extending portion 52 located generally at the primary seal member outer radial end 30b and a radially-extending portion 54 located generally at the primary seal member first axial end 32A, as indicated in FIGS. 2 and 5. As such, the backing ring 50 is configured to reinforce the “back end” section of the primary seal outer radial end 30b opposite the section of the inner radial end 30a subjected to the pressure of fluid within the passages 16, 20, while minimizing weight and material requirements of the ring 50. Further, the backing ring 50 is preferably coupled with the primary seal member 30 by an adhesive or thermal bonding. However, the backing ring 50 may be formed in any other appropriate manner, such as a solid circular ring, and/or attached to the primary seal member 30 in any other appropriate manner (e.g., fasteners).

Referring to FIGS. 2, 5 and 6, the primary seal member 30 is preferably formed having at least one annular axial shoulder 36 extending generally axially-outwardly from a remainder of the primary member first axial end 32A, which provides an axial recessed section 38. The shoulder 36 has an inner end 36a integral with a remainder of the primary seal member 30 and an opposing, free outer end 36b providing the primary sealing surface 34, and is preferably formed with generally rectangular axial cross-sections. Preferably, the annular seal body 31 is formed having axial cross-sections that taper inwardly in the radially outward direction, such that axial thickness (i.e., between the axial ends 32A, 32B; not indicated) of the body 31 is greatest at the radial inner end 30b and is least at the radial outer end 30b. Thereby, material compression of the primary seal member 30 is greatest in the region of the axial shoulder 36 to ensure proper engagement of the sealing surface 34 with the first tubular member annular surface 18. Further the primary seal member 30 also preferably has an annular radial shoulder 60 extending radially outwardly from a remainder of the seal member outer radial end 30b so as to define a radial recessed section 62. The radial shoulder 60 has an outer circumferential surface 64 disposeable generally against the inner circumferential surface 28 of the second tubular member collar portion 26 when the seal assembly 10 is installed within the annular space/seal gland G_{S}.

With the above structure of the primary seal member 30, the secondary seal member 40 is preferably disposed circumferentially about the axial shoulder 36 of the primary seal member 30 and is preferably sized such that an inside diameter (not indicated) of the secondary seal member 40 is slightly larger than an outside diameter (not indicated) of the axial shoulder 36. However, the axial shoulder 36 and secondary seal member 40 may be alternatively sized so as to engage with an interference fit to assist in retaining the secondary member 40 on the primary member 30, or even to define a gap (not shown) between the shoulder 36 and the seal member 40.

Further, the secondary seal second axial end 42B is disposed generally against at least a section of the recessed side portion 38 of the primary member first axial end 32A, and the secondary seal member 40 preferably has an axial thickness (i.e., between the axial ends 42A, 42B) about equal to the axial length (not indicated) of the axial shoulder 36. Thereby, the primary sealing surface 34 and the secondary sealing surface 44 are generally radially “flush” or located generally within the same radial plane (not indicated) when the assembly 10 is installed in the gland G_{S}, as best shown in FIG. 2. Preferably, the secondary seal member 40 is attached the primary seal member 30 by an adhesive or by thermal bonding, but may be coupled by any other appropriate means (e.g., fasteners, etc.).

As best shown in FIGS. 2 and 5, the backing ring 50 is preferably coupled with the primary seal member 30 such that the ring axial portion 52 is disposed circumferentially about and against the recessed axial section 62 of the radial outer end 30b and abuts the radial shoulder 60. The ring radial portion 54 is disposed against a portion of the recessed axial section 38, such that the secondary seal member 40 is disposed generally radially between the backing ring 50 and the axial shoulder 36 of the primary seal member 30. The backing ring 50 may be attached to the primary seal member 30 by any appropriate means, such as by an adhesive, thermal bonding, fasteners, etc.

Referring again to FIGS. 1-6, the sealing assembly 10 is preferably formed or fabricated to be axially symmetric so as to be reversible, i.e., capable of being installed so that either axial end 32A, 32B of the primary sealing member 30 is sealingly engageable with the annular end surface 18 of the first tubular member 12. More specifically, the primary sealing surface 34 is a first primary sealing surface 35A provided on a first axial shoulder 37A and the primary seal member 30 further has a second radially-extending primary sealing surface 35B provided on the second axial end 32B of the primary seal member 30. The second primary sealing surface 35B is preferably provided on a second annular shoulder 37B extending axially outwardly from the second axial end 32B, the second primary sealing surface 35B being sealingly engageable with the second tubular member end surface 22 in a first orientation of the seal assembly 10, as best shown in FIGS. 1 and 2. Alternatively, if installed in a second or reversed orientation, the second primary sealing surface 35B sealingly engages the end surface 18 of the first tubular member 12 while the first primary sealing surface 35A engages the end surface 22 of the second tubular member 14 (orientation not depicted).

Further, the secondary seal member 40 is preferably a first secondary seal member 43A with a first secondary sealing surface 45A and the seal assembly 10 further comprises a second secondary seal member 43B having a second secondary sealing surface 45B. The second secondary seal member 43A is coupled with the primary seal member 30 such that the secondary sealing surface 45B extends generally coaxially about the second primary sealing surface 35B, preferably about the second axial shoulder 37B. When the seal assembly 10 is installed in one orientation as depicted in the drawing figures, the second secondary sealing surface 45B is sealingly engageable with the second tubular member end surface 22 and when installed in the reversed orientation, the second secondary sealing surface 45B is sealingly engageable with the end surface 18 of the first tubular member 12. Both the first and second secondary seal members 43A, 43B are preferably identically constructed and formed as described in detail above.

Furthermore, the backing ring 50 is preferably a first backing ring 51A and the seal assembly 10 preferably further comprises a second backing ring 51B formed generally identical with the first backing ring 50 and as described as above. The second backing ring 51B is disposed on the primary seal member 30 such that the ring axial portion 52 extends along a second radial recessed portion 62 on the primary seal member outer radial end 30b and the ring radial portion 54 extends along a second axial recessed portion 38 on the seal member second axial end 32B. The second backing ring 51B functions to prevent extrusion of the primary seal member 30 in the region of the outer axial end 30b when the seal assembly 10 is arranged in the second orientation (not shown).

Thus, with the preferred symmetric structure, the seal assembly 10 may be installed within the annular gland G_{S} such that either primary sealing surface 35A or 35B and the associated secondary sealing surface 45A, 45B, respectively, sealingly engages the end surface 18 of the first tubular member 12. However, the seal assembly 10 may alternatively be formed having only a single primary sealing surface 34, preferably provided on an annular axial shoulder 36, a single secondary seal member 40 with a secondary sealing surface 44, and a single backing ring 50.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as generally defined in the appended claims.

We claim:

1. A seal assembly for sealing between first and second tubular members, each tubular member having a central passage and a generally annular end surface surrounding the passage, the first member passage being fluidly coupled with the second member passage, the first member end surface facing and being spaced apart from the second member end surface along a central axis, and the first member being angularly displaceable about the axis with respect to the second member, the seal assembly comprising:
a generally annular primary seal member formed of a first, generally compressible polymeric material, the primary seal member having inner and outer radial ends, a first axial end disposeable against the first tubular member end surface and a second axial end disposeable against the second tubular member end surface, the first axial end having a radially-extending, generally annular primary sealing surface sealingly engageable with the first tubular member end surface; and
a generally annular secondary seal member formed of a second, generally rigid polymeric material, the secondary seal member having opposing first and second axial ends and a radially-extending, generally annular secondary sealing surface on the first axial end, the secondary seal member being coupled with the first seal member such that the secondary sealing surface extends generally coaxially about the primary sealing surface, the secondary sealing surface being sealingly engageable with the first tubular member end surface.

2. The seal assembly as recited in claim 1 wherein the second polymeric material has a coefficient of friction substantially lesser than a coefficient of friction of the first material.

3. The seal assembly as recited in claim 2 wherein the first polymeric material is an elastomer and the second polymeric material is a thermoplastic polymer.

4. The seal assembly as recited in claim 1 further comprising a metallic backing ring coupled with the primary seal member such that a portion of the backing ring is disposeable against the first tubular member end surface, the secondary seal member being disposed radially between the backing ring and the primary seal member inner end.

5. The seal assembly as recited in claim 4 wherein the backing ring has an axially-extending portion located generally at the primary seal member outer radial end and a radially-extending portion located generally at the primary seal member first axial end.

6. The seal assembly as recited in claim 1 wherein:
the primary seal member has an integral annular shoulder extending generally axially-outwardly from a remainder of the primary member first axial end, the shoulder having a free outer end providing the primary sealing surface; and
the secondary seal member is disposed circumferentially about the primary seal member shoulder and has a first axial end providing the secondary sealing surface and a second axial end disposed generally against at least a portion of the remainder of the primary member first axial end.

7. The seal assembly as recited in claim 1 wherein the primary seal member has an outer circumferential surface on the outer radial end, the seal member outer circumferential surface being disposeable generally against an inner circumferential surface of the second tubular member.

8. The seal assembly as recited in claim 1 wherein the secondary seal member has a first axial end providing the secondary sealing surface and a second axial end disposed generally against the primary seal member such that:
when one of the first and second tubular members displaces axially toward the other one of the first and second tubular members, the primary seal member compresses between the first and second tubular members while the secondary sealing surface remains sealingly engaged with the first tubular member; and
when one of the first and second members displaces axially away from the other one of the first and second tubular members, the primary seal member expands between the first and second tubular members while the secondary sealing surface remains sealingly engaged with the first tubular member.

9. The seal assembly as recited in claim 1 wherein:
the primary sealing surface is a first primary sealing surface and the primary seal member has a second radially-extending primary sealing surface on the second axial end of the primary seal member, the second primary sealing surface being sealingly engageable with the second tubular member end surface; and
the secondary seal member is a first secondary seal member and the seal assembly further comprises a second secondary seal member having a second secondary sealing surface and being coupled with the primary seal member such that the secondary sealing surface extends generally coaxially about the second primary sealing surface, the second secondary sealing surface being sealingly engageable with the second tubular member end surface.

10. A mechanical assembly comprising:
a first tubular member having a central passage and a generally annular end surface surrounding the passage;
a second tubular member having a central passage and a generally annular end surface surrounding the passage, the first member end surface facing and being spaced apart along a central axis from the second member end surface and the first member being angularly displaceable about the axis with respect to the second member;
a seal assembly for sealing between the first and second member end surfaces and including:
a generally annular primary seal member formed of a first, generally compressible polymeric material, the primary seal member having inner and outer radial ends, a first axial end disposeable against the first tubular member end surface and a second axial end disposeable against the second tubular member end surface, the first axial end having a radially-extending, generally annular primary sealing surface sealingly engageable with the first tubular member end surface; and
a generally annular secondary seal member formed of a second, generally rigid polymeric material, the secondary seal member having opposing first and second axial ends and a radially-extending, generally annular secondary sealing surface on the first axial end, the secondary seal member being coupled with the first seal member such that the secondary sealing surface extends generally coaxially about the primary sealing surface, the secondary sealing surface being sealingly engageable with the first tubular member end surface.

11. The mechanical assembly as recited in claim 10 wherein the second polymeric material has a coefficient of friction substantially lesser than a coefficient of friction of the first material.

12. The mechanical assembly as recited in claim 11 wherein the first polymeric material is an elastomer and the second polymeric material is a thermoplastic polymer.

13. The mechanical assembly as recited in claim 10 wherein the seal assembly further includes a metallic backing ring coupled with the primary seal member such that a portion of the backing ring is disposeable against the first tubular member end surface, the secondary seal member being disposed radially between the backing ring and the primary seal member inner end.

14. The mechanical assembly as recited in claim 13 wherein the backing ring has an axially-extending portion located generally at the primary seal member outer radial end and a radially-extending portion located generally at the primary seal member first axial end.

15. The mechanical assembly as recited in claim 10 wherein:
the primary seal member has an integral annular shoulder extending generally axially-outwardly from a remainder of the primary member first axial end, the shoulder having a free outer end providing the primary sealing surface; and
the secondary seal member is disposed circumferentially about the primary seal member shoulder and has a first axial end providing the secondary sealing surface and a second axial end disposed generally against at least a portion of the remainder of the primary member first axial end.

16. The mechanical assembly as recited in claim 10 wherein the primary seal member has an outer circumferential surface on the outer radial end, the seal member outer circumferential surface being disposeable generally against an inner circumferential surface of the second tubular member.

17. The mechanical assembly as recited in claim 10 wherein the secondary seal member has a first axial end providing the secondary sealing surface and a second axial end disposed generally against the primary seal member such that:
when one of the first and second tubular members displaces axially toward the other one of the first and second tubular members, the primary seal member compresses between the first and second tubular members while the secondary sealing surface remains sealingly engaged with the first tubular member; and
when one of the first and second members displaces axially away from the other one of the first and second tubular members, the primary seal member expands between the first and second tubular members while the secondary sealing surface remains sealingly engaged with the first tubular member.

18. The mechanical assembly as recited in claim 10 wherein:
the primary sealing surface is a first primary sealing surface and the primary seal member has a second radially-extending primary sealing surface on the second axial end of the primary seal member, the second primary sealing surface being sealingly engageable with the second tubular member end surface; and
the secondary seal member is a first secondary seal member and the seal assembly further comprises a second secondary seal member having a second secondary sealing surface and being coupled with the primary seal member such that the secondary sealing surface extends generally coaxially about the second primary sealing surface, the second secondary sealing surface being sealingly engageable with the second tubular member end surface.
